(19) United States
(12) Patent Application Publication
(10) Pub. No.: US 2023/0167006 A1
(43) Pub. Date: Jun. 1, 2023

(54) ION-EXCHANGEABLE ZIRCONIUM CONTAINING GLASSES WITH HIGH CT AND CS CAPABILITY

(71) Applicant: CORNING INCORPORATED, Corning, NY (US)

(72) Inventors: Xiaoju Guo, Pittsford, NY (US); Peter Joseph Lezzi, Corning, NY (US); Jian Luo, Cupertino, CA (US)

(21) Appl. No.: 17/994,636

(22) Filed: Nov. 28, 2022

Related U.S. Application Data
(60) Provisional application No. 63/283,648, filed on Nov. 29, 2021.

(51) Int. Cl. C03C 3/087; C03C 3/095; C03C 21/00

(52) U.S. Cl. CPC C03C 3/087; C03C 3/095; C03C 21/002

(57) ABSTRACT

A glass is provided, comprising: greater than or equal to 50.4 mol % to less than or equal to 60.5 mol % SiO₂; greater than or equal to 16.4 mol % to less than or equal to 19.5 mol % Al₂O₃; greater than or equal to 2.4 mol % to less than or equal to 9.5 mol % B₂O₃; greater than or equal to 0 mol % to less than or equal to 5.5 mol % MgO; greater than or equal to 0.4 mol % to less than or equal to 7.5 mol % CaO; greater than or equal to 0 mol % to less than or equal to 3.5 mol % ZnO; greater than or equal to 7.4 mol % to less than or equal to 11.5 mol % Li₂O; greater than 0.4 mol % to less than or equal to 5.5 mol % Na₂O; greater than or equal to 0 mol % to less than or equal to 1.0 mol % K₂O; greater than 0.1 mol % to less than or equal to 1.5 mol % ZrO₂; and greater than or equal to 0 mol % to less than or equal to 2.5 mol % Y₂O₃. Related articles and methods are also provided.

This application claims the benefit of priority under 35 U.S.C. § 119 of U.S. Provisional Application Ser. No. 63/283,648 filed on Nov. 29, 2021, the content of which is relied upon and incorporated herein by reference in its entirety.

### BACKGROUND

### Field

The present specification generally relates to glass compositions suitable for use as cover glass for electronic devices. More specifically, the present specification is directed to ion exchangeable glasses that may be formed into cover glass for electronic devices.

### Technical Background

The mobile nature of portable devices, such as smart phones, tablets, portable media players, personal computers, and cameras, makes these devices particularly vulnerable to accidental dropping on hard surfaces, such as the ground. These devices typically incorporate cover glasses, which may become damaged upon impact with hard surfaces. In many of these devices, the cover glasses function as display covers, and may incorporate touch functionality, such that use of the devices is negatively impacted when the cover glasses are damaged.

There are two major failure modes of cover glass when the associated portable device is dropped on a hard surface. One of the modes is flexure failure, which is caused by bending of the glass when the device is subjected to dynamic load from impact with the hard surface. The other mode is sharp contact failure, which is caused by introduction of damage to the glass surface. Impact of the glass with rough hard surfaces, such as asphalt, granite, etc., can result in sharp indentations in the glass surface. These indentations become failure sites in the glass surface from which cracks may develop and propagate.

Glass can be made more resistant to flexure failure by the ion-exchange technique, which involves inducing compressive stress in the glass surface. However, the ion-exchanged glass will still be vulnerable to dynamic sharp contact, owing to the high stress concentration caused by local indentations in the glass from the sharp contact.

It has been a continuous effort for glass makers and handheld device manufacturers to improve the resistance of handheld devices to sharp contact failure. Solutions range from coatings on the cover glass to bezels that prevent the cover glass from impacting the hard surface directly when the device drops on the hard surface. However, due to the constraints of aesthetic and functional requirements, it is very difficult to completely prevent the cover glass from impacting the hard surface.

It is also desirable that portable devices be as thin as possible. Accordingly, in addition to strength, it is also desired that glasses to be used as cover glass in portable devices be made as thin as possible. Thus, in addition to increasing the strength of the cover glass, it is also desirable for the glass to have mechanical characteristics that allow it to be formed by processes that are capable of making thin glass-based articles, such as thin glass sheets or substrates.

Accordingly, a need exists for glasses that can be strengthened, such as by ion exchange, and that have the mechanical properties that allow them to be formed as thin glass-based articles.

### SUMMARY

According to aspect (1), a glass comprises:

greater than or equal to 50.4 mol % to less than or equal to 60.5 mol % SiO₂;

greater than or equal to 16.4 mol % to less than or equal to 19.5 mol % Al₂O₃;

greater than or equal to 2.4 mol % to less than or equal to 9.5 mol % B₂O₃;

greater than or equal to 0 mol % to less than or equal to 5.5 mol % MgO;

greater than or equal to 0.4 mol % to less than or equal to 7.5 mol % CaO;

greater than or equal to 0 mol % to less than or equal to 3.5 mol % ZnO;

greater than or equal to 7.4 mol % to less than or equal to 11.5 mol % Li₂O;

greater than 0.4 mol % to less than or equal to 5.5 mol % Na₂O;

greater than or equal to 0 mol % to less than or equal to 1.0 mol % K₂O;

greater than 0.1 mol % to less than or equal to 1.5 mol % ZrO₂; and

greater than or equal to 0 mol % to less than or equal to 2.5 mol % Y₂O₃.

According to aspect (2), aspect (1) comprises greater than 0.2 mol % to less than or equal to 1.0 mol % ZrO₂.

According to aspect (3), any of aspects (1) through (2) comprise greater than 0.3 mol % to less than or equal to 0.8 mol % ZrO₂.

According to aspect (4), any of aspects (1) through (3) comprise greater than or equal to 51.0 mol % to less than or equal to 60.0 mol % SiO₂.

According to aspect (5), any of aspects (1) through (4) comprise greater than or equal to 17.5 mol % to less than or equal to 19.0 mol % Al₂O₃.

According to aspect (6), any of aspects (1) through (5) comprise greater than or equal to 3.5 mol % to less than or equal to 9.0 mol % B₂O₃.

According to aspect (7), any of aspects (1) through (6) comprise greater than or equal to 0.08 mol % to less than or equal to 4.8 mol % MgO.

According to aspect (8), any of aspects (1) through (7) comprise greater than or equal to 1.0 mol % to less than or equal to 6.5 mol % CaO.

According to aspect (9), any of aspects (1) through (8) comprise greater than or equal to 0 mol % to less than or equal to 2.1 mol % ZnO.

According to aspect (10), any of aspects (1) through (9) comprise greater than or equal to 8.9 mol % to less than or equal to 11.0 mol % Li₂O.

According to aspect (11), any of aspects (1) through (10) comprise greater than 1.8 mol % to less than or equal to 4.3 mol % Na₂O.

According to aspect (12), any of aspects (1) through (11) comprise greater than or equal to 0.1 mol % to less than or equal to 0.5 mol % K₂O.

According to aspect (13), any of aspects (1) through (12) comprise greater than or equal to 0 mol % to less than or equal to 1.1 mol % Y₂O₃.

According to aspect (14), any of aspects (1) through (13) comprise:

greater than or equal to 51.9 mol % to less than or equal to 59.1 mol % SiO₂;

greater than or equal to 17.5 mol % to less than or equal to 18.9 mol % Al₂O₃;

greater than or equal to 3.8 mol % to less than or equal to 8.1 mol % B₂O₃;

greater than or equal to 0.05 mol % to less than or equal to 4.8 mol % MgO;

greater than or equal to 1.0 mol % to less than or equal to 6.1 mol % CaO;

greater than or equal to 0 mol % to less than or equal to 2.1 mol % ZnO;

greater than or equal to 8.9 mol % to less than or equal to 11.0 mol % Li₂O;

greater than 1.8 mol % to less than or equal to 4.3 mol % Na₂O;

greater than or equal to 0.15 mol % to less than or equal to 0.25 mol % K₂O;

greater than 0.2 mol % to less than or equal to 1.1 mol % ZrO₂; and

greater than or equal to 0 mol % to less than or equal to 1.1 mol % Y₂O₃.

According to aspect (15), any of aspects (1) through (14) comprise:

greater than or equal to 57.0 mol % to less than or equal to 59.0 mol % SiO₂;

greater than or equal to 18.0 mol % to less than or equal to 18.9 mol % Al₂O₃;

greater than or equal to 3.8 mol % to less than or equal to 5.0 mol % B₂O₃;

greater than or equal to 1.5 mol % to less than or equal to 2.5 mol % MgO;

greater than or equal to 3.0 mol % to less than or equal to 4.0 mol % CaO;

greater than or equal to 0 mol % to less than or equal to 0.5 mol % ZnO;

greater than or equal to 9.0 mol % to less than or equal to 10.0 mol % Li₂O;

greater than 3.0 mol % to less than or equal to 4.0 mol % Na₂O;

greater than or equal to 0.15 mol % to less than or equal to 0.25 mol % K₂O;

greater than 0.4 mol % to less than or equal to 0.8 mol % ZrO₂; and

greater than or equal to 0 mol % to less than or equal to 0.5 mol % Y₂O₃.

According to aspect (16), any of aspects (1) through (15) comprise a fracture toughness K₁C greater than or equal to 0.7.

According to aspect (17), any of aspects (1) through (16) comprise a fracture toughness K₁C greater than or equal to 0.75.

According to aspect (18), any of aspects (1) through (17) comprise a fracture toughness K₁C greater than or equal to 0.7 and less than or equal to 0.9.

According to aspect (19), any of aspects (1) through (18) comprise a 10^{7.6} P softening point less than or equal to 850° C.

According to aspect (20), any of aspects (1) through (19) comprise a 10^{7.6} P softening point greater than or equal to 750° C. less than or equal to 850° C.

According to aspect (21), any of aspects (1) through (20) comprise a 10^{7.6} P softening point greater than or equal to 750° C. less than or equal to 835° C.

According to aspect (22), an article comprises:

a glass-based substrate, the glass-based substrate further comprising:

a compressive stress layer extending from a surface of the glass-based substrate to a depth of compression;

a central tension region; and

a composition at a center of the glass-based substrate comprising:

greater than or equal to 50.4 mol % to less than or equal to 60.5 mol % SiO2;

greater than or equal to 16.4 mol % to less than or equal to 19.5 mol % Al2O3;

greater than or equal to 2.4 mol % to less than or equal to 9.5 mol % B2O₃;

greater than or equal to 0 mol % to less than or equal to 5.5 mol % MgO;

greater than or equal to 0.4 mol % to less than or equal to 7.5 mol % CaO;

greater than or equal to 0 mol % to less than or equal to 3.5 mol % ZnO;

greater than or equal to 7.4 mol % to less than or equal to 11.5 mol % Li2O;

greater than 0.4 mol % to less than or equal to 5.5 mol % Na2O;

greater than or equal to 0 mol % to less than or equal to 1.0 mol % K2O;

greater than 0.1 mol % to less than or equal to 1.5 mol % ZrO2; and

greater than or equal to 0 mol % to less than or equal to 2.5 mol % Y2O3.

According to aspect (23), the glass-based substrate of aspect (22) greater than 0.3 mol % to less than or equal to 0.8 mol % ZrO₂.

According to aspect (24), the glass-based substrate of any of aspects (22) through (23) comprises greater than or equal to 51.0 mol % to less than or equal to 60.0 mol % SiO₂.

According to aspect (25), the glass-based substrate of any of aspects (22) through (24) comprises greater than or equal to 17.5 mol % to less than or equal to 19.0 mol % Al₂O₃.

According to aspect (26), the glass-based substrate of any of aspects (22) through (25) comprises greater than or equal to 3.5 mol % to less than or equal to 9.0 mol % B₂O₃.

According to aspect (27), the glass-based substrate of any of aspects (22) through (26) comprises greater than or equal to 0.08 mol % to less than or equal to 4.8 mol % MgO.

According to aspect (28), the glass-based substrate of any of aspects (22) through (27) comprises greater than or equal to 1.0 mol % to less than or equal to 6.5 mol % CaO.

According to aspect (29), the glass-based substrate of any of aspects (22) through (28) comprises greater than or equal to 0 mol % to less than or equal to 2.1 mol % ZnO.

According to aspect (30), the glass-based substrate of any of aspects (22) through (29) comprises greater than or equal to 8.9 mol % to less than or equal to 11.0 mol % Li₂O.

According to aspect (31), the glass-based substrate of any of aspects (22) through (30) comprises greater than 1.8 mol % to less than or equal to 4.3 mol % Na₂O.

According to aspect (32), the glass-based substrate of any of aspects (22) through (31) comprises greater than or equal to 0.1 mol % to less than or equal to 0.5 mol % K₂O.

According to aspect (33), the glass-based substrate of any of aspects (22) through (32) comprises greater than or equal to 0 mol % to less than or equal to 1.1 mol % Y₂O₃.

According to aspect (34), the glass-based substrate of any of aspects (22) through (33) comprises:

greater than or equal to 51.9 mol % to less than or equal to 59.1 mol % SiO₂;

greater than or equal to 17.5 mol % to less than or equal to 18.9 mol % Al₂O₃;

greater than or equal to 3.8 mol % to less than or equal to 8.1 mol % B₂O₃;

greater than or equal to 0.05 mol % to less than or equal to 4.8 mol % MgO;

greater than or equal to 1.0 mol % to less than or equal to 6.1 mol % CaO;

greater than or equal to 0 mol % to less than or equal to 2.1 mol % ZnO;

greater than or equal to 8.9 mol % to less than or equal to 11.0 mol % Li₂O;

greater than 1.8 mol % to less than or equal to 4.3 mol % Na₂O;

greater than or equal to 0.15 mol % to less than or equal to 0.25 mol % K₂O;

greater than 0.2 mol % to less than or equal to 1.1 mol % ZrO₂; and

greater than or equal to 0 mol % to less than or equal to 1.1 mol % Y₂O₃.

According to aspect (35), the glass-based substrate of any of aspects (22) through (34) comprises:

greater than or equal to 57.0 mol % to less than or equal to 59.0 mol % SiO₂;

greater than or equal to 18.0 mol % to less than or equal to 18.9 mol % Al₂O₃;

greater than or equal to 3.8 mol % to less than or equal to 5.0 mol % B₂O₃;

greater than or equal to 1.5 mol % to less than or equal to 2.5 mol % MgO;

greater than or equal to 3.0 mol % to less than or equal to 4.0 mol % CaO;

greater than or equal to 0 mol % to less than or equal to 0.5 mol % ZnO;

greater than or equal to 9.0 mol % to less than or equal to 10.0 mol % Li₂O;

greater than 3.0 mol % to less than or equal to 4.0 mol % Na₂O;

greater than or equal to 0.15 mol % to less than or equal to 0.25 mol % K₂O;

greater than 0.4 mol % to less than or equal to 0.8 mol % ZrO₂; and

greater than or equal to 0 mol % to less than or equal to 0.5 mol % Y₂O₃.

According to aspect (36), the glass-based substrate of any of aspects (22) through (35) comprises a fracture toughness K₁C greater than or equal to 0.7.

According to aspect (37), the glass-based substrate of any of aspects (22) through (36) comprises a fracture toughness K₁C greater than or equal to 0.75.

According to aspect (38), the glass-based substrate of any of aspects (22) through (37) comprises a fracture toughness K₁C greater than or equal to 0.7 and less than or equal to 0.9.

According to aspect (39), the glass-based substrate of any of aspects (22) through (38) comprises a 10^{7.6} P softening point less than or equal to 850° C.

According to aspect (40), the glass-based substrate of any of aspects (22) through (39) comprises a 10^{7.6} P softening point greater than or equal to 750° C. less than or equal to 850° C.

According to aspect (41), the glass-based substrate of any of aspects (22) through (40) comprises a 10^{7.6} P softening point greater than or equal to 750° C. less than or equal to 835° C.

According to aspect (42), the glass-based substrate of any of aspects (22) through (41) comprises a CS greater than or equal to 1 GPa.

According to aspect (43), the glass-based substrate of any of aspects (22) through (42) comprises a CT greater than or equal to 195 MPa.

According to aspect (44), the article of any of aspects (22) through (43) is a consumer electronic product, comprising:

a housing having a front surface, a back surface and side surfaces;

electrical components provided at least partially within the housing, the electrical components including at least a controller, a memory, and a display, the display being provided at or adjacent the front surface of the housing; and

the glass based substrate, wherein the glass-based substrate is disposed over the display.

According to aspect (45), the article of any of aspects (22) through (44) is the glass-based substrate.

According to aspect (46), the glass-based substrate of any of aspects (22) through (45) is transparent.

According to aspect (47), the glass-based substrate of any of aspects (22) through (46) has a thickness greater than or equal to 0.2 mm to less than or equal to 2.0 mm.

According to aspect (48), a method comprises:

ion exchanging a glass-based substrate in a molten salt bath to form a glass-based article,

wherein the glass-based substrate comprises a compressive stress layer extending from a surface of the glass-based article to a depth of compression, the glass-based substrate comprises a central tension region, and the glass-based substrate comprises the glass of any of aspects (1) to (21).

According to aspect (49), the molten salt bath of aspect (48) comprises NaNO₃.

According to aspect (50), the molten salt bath of any of aspects (48) through (49) comprises KNO₃.

According to aspect (51), the molten salt bath of any of aspects (48) though (50) is at a temperature greater than or equal to 400° C. to less than or equal to 550° C.

According to aspect (52), the ion exchanging of any of aspects (48) through (51) extends for a time period greater than or equal to 0.5 hours to less than or equal to 48 hours.

According to aspect (53), the method of any of aspects (48) through (52) further comprises ion exchanging the glass-based substrate in a second molten salt bath.

According to aspect (54), the second molten salt bath of aspect (53) comprises KNO₃.

### BRIEF DESCRIPTION OF THE DRAWINGS

FIG. 1 schematically depicts a cross section of a glass-based substrate having compressive stress regions according to embodiments described and disclosed herein;

FIG. 2A is a plan view of an exemplary electronic device incorporating any of the glass-based substrates disclosed herein; and

FIG. 2B is a perspective view of the exemplary electronic device of FIG. 2A.

### DETAILED DESCRIPTION

Reference will now be made in detail to lithium aluminosilicate glasses according to various embodiments. Lithium aluminosilicate glasses have good ion exchangeability, and chemical strengthening processes have been used to achieve high strength and high toughness properties in lithium aluminosilicate glasses. Lithium aluminosilicate glasses are highly ion exchangeable glasses with high glass quality. The substitution of Al₂O₃ into the silicate glass network increases the interdiffusivity of monovalent cations during ion exchange. By chemical strengthening in a molten salt bath (e.g., KNO₃ or NaNO₃), glasses with high strength, high toughness, and high indentation cracking resistance can be achieved. The stress profiles achieved through chemical strengthening may have a variety of shapes that increase the drop performance, strength, toughness, and other attributes of the glass-based substrates.

Therefore, lithium aluminosilicate glasses with good physical properties, chemical durability, and ion exchangeability have drawn attention for use as cover glass. In particular, lithium containing aluminosilicate glasses, which have higher fracture toughness and reasonable raw material costs, are provided herein. Through different ion exchange processes, greater central tension (CT), depth of compression (DOC), and high compressive stress (CS) can be achieved. However, the addition of lithium in the aluminosilicate glass may reduce the melting point, softening point, or liquidus viscosity of the glass.

Specifically, lithium aluminosilicate glasses containing 0.1 mol % to 1.5 mol % ZrO₂ are provided. The use of ZrO₂ in a composition space where ZrO₂ had not been previously introduced leads to an unexpectedly good combination of properties including high fracture toughness, high overall compressive stress (measured by CT), high surface compressive stress (CS), low softening point and low liquidus, making the glass compositions disclosed herein leading candidates for next-gen cover glass and also readily useable with certain convenient manufacturing processes such as slot-draw and fusion.

In embodiments of glass compositions described herein, the concentration of constituent components (e.g., SiO₂, Al₂O₃, Li₂O, and the like) are given in mole percent (mol %) on an oxide basis, unless otherwise specified. Components of the alkali aluminosilicate glass composition according to embodiments are discussed individually below. It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits.

As utilized herein, a “glass-based” substrate refers to substrate that is made of glass or glass-ceramic. A “glass-based substrate” includes substrates that have been ion-exchanged, as well as substrates that have not been ion-exchanged. An “article” may be made wholly or partly of glass-based materials, such as glass substrates that include a surface coating, or electronic devices that include a glass substrate.

Drop performance is a leading attribute for glass-based substrates incorporated into mobile electronic devices. Fracture toughness and stress at depth are critical for improved drop performance on rough surfaces. For this reason, maximizing the amount of stress that can be provided in a glass before reaching frangibility limit increases the stress at depth and the rough surface drop performance. The fracture toughness is known to control the frangibility limit and increasing the fracture toughness increases the frangibility limit. The glass compositions disclosed herein have a high fracture toughness and are capable of achieving high compressive stress levels while remaining non-frangible. These characteristics of the glass compositions enable the development of improved stress profiles designed to address particular failure modes. This capability allows the ion exchanged glass-based substrates produced from the glass compositions described herein to be customized with different stress profiles to address particular failure modes of concern.

### Components

ZrO₂ dramatically increases fracture toughness in the composition spaces discussed herein. However, ZrO₂ also has low solubility in that composition space. This low solubility can lead to undesirable secondary zircon formation during manufacture. This zircon formation can be avoided in at least two ways, individually or in combination. First, it is helpful to avoid the use of manufacturing equipment, such as zircon isopipes, that can encourage secondary zircon formation. Second, a limited about of Y₂O₃ can raise the solubility of ZrO₂.

In the glass compositions described herein, SiO₂ is the largest constituent and, as such, SiO₂ is the primary constituent of the glass network formed from the glass composition. Pure SiO₂ has a relatively low CTE. However, pure SiO₂ has a high melting point. Accordingly, if the concentration of SiO₂ in the glass composition is too high, the formability of the glass composition may be diminished as higher concentrations of SiO₂ increase the difficulty of melting the glass, which, in turn, adversely impacts the formability of the glass. If the concentration of SiO₂ in the glass composition is too low the chemical durability of the glass may be diminished, and the glass may be susceptible to surface damage during post-forming treatments. In embodiments, the glass composition generally comprises SiO₂ in an amount of greater than or equal to 50.4 mol % to less than or equal to 60.5 mol % SiO₂, such as greater than or equal to 51.9 mol % to less than or equal to 59.1 mol % SiO₂, greater than or equal to 57.0 mol % to less than or equal to 59.0 mol % SiO₂; and all ranges and sub-ranges between the foregoing values.

The glass compositions include Al₂O₃. Al₂O₃ may serve as a glass network former, similar to SiO₂. Al₂O₃ may increase the viscosity of the glass composition due to its tetrahedral coordination in a glass melt formed from a glass composition, decreasing the formability of the glass composition when the amount of Al₂O₃ is too high. However, when the concentration of Al₂O₃ is balanced against the concentration of SiO₂ and the concentration of alkali oxides in the glass composition, Al₂O₃ can reduce the liquidus temperature of the glass melt, thereby enhancing the liquidus viscosity and improving the compatibility of the glass composition with certain forming processes. The inclusion of Al₂O₃ in the glass compositions contributes to the high fracture toughness values described herein. In embodiments, the glass composition comprises Al₂O₃ in a concentration of from greater than or equal to 16.4 mol % to less than or equal to 19.5 mol %, such as greater than or equal to 17.5 mol % to less than or equal to 18.9 mol %, greater than or equal to 18.0 mol % to less than or equal to 18.9 mol %, and all ranges and sub-ranges between the foregoing values.

The glass compositions described herein include B₂O₃. The inclusion of B₂O₃ increases the fracture toughness of the glass. In particular, the glass compositions include boron in the trigonal configuration which increases the Knoop scratch threshold and fracture toughness of the glasses. If too much B₂O₃ is included in the composition the amount of compressive stress imparted in an ion exchange process may be reduced and volatility at free surfaces during manufacturing may increase to undesirable levels. In embodiments, the glass composition comprises B₂O₃ in an amount from greater than or equal to 2.4 mol % to less than or equal to 9.5 mol %, such as greater than or equal to 3.8 mol % to less than or equal to 8.1 mol %, greater than or equal to 3.8 mol % to less than or equal to 5.0 mol %, and all ranges and sub-ranges between the foregoing values.

The glass compositions described herein may include MgO. MgO may lower the viscosity of a glass, which enhances the formability and manufacturability of the glass. The inclusion of MgO in a glass composition may also improve the strain point and the Young's modulus of the glass composition. However, if too much MgO is added to the glass composition, the liquidus viscosity may be too low for compatibility with desirable forming techniques. The addition of too much MgO may also increase the density and the CTE of the glass composition to undesirable levels. The inclusion of MgO in the glass composition also helps to achieve the high fracture toughness values described herein. In embodiments, the glass composition comprises MgO in an amount from greater than or equal to 0 mol % to less than or equal to 5.5 mol %, such as greater than 0.05 mol % to less than or equal to 4.8 mol %, greater than or equal to 0.5 mol % to less than or equal to 3.5 mol %, greater than or equal to 1.5 mol % to less than or equal to 2.5 mol %, and all ranges and sub-ranges between the foregoing values. In embodiments, the glass composition is substantially free or free of MgO. As used herein, the term “substantially free” means that the component is not purposefully added as a component of the batch material even though the component may be present in the final glass composition in very small amounts as a contaminant, such as less than 0.1 mol %.

The glass compositions described herein may include CaO. CaO may lower the viscosity of a glass, which may enhance the formability, the strain point, and the Young's modulus. However, if too much CaO is added to the glass composition, the density and the CTE of the glass composition may increase to undesirable levels and the ion exchangeability of the glass may be undesirably impeded. The inclusion of CaO in the glass composition also helps to achieve the high fracture toughness values described herein. In embodiments, the glass composition comprises CaO in an amount from greater than or equal to 0.4 mol % to less than or equal to 7.5 mol %, such as greater than or equal to 1.0 mol % to less than or equal to 6.1 mol %, greater than or equal to 3 mol % to less than or equal to 4 mol %, and all ranges and sub-ranges between the foregoing values. In embodiments, the glass composition is substantially free or free of CaO.

The glass compositions described herein may include ZnO. ZnO may lower the viscosity of a glass, which may enhance the formability, the strain point, and the Young's modulus. However, if too much ZnO is added to the glass composition, the density and the CTE of the glass composition may increase to undesirable levels. The inclusion of ZnO in the glass composition also helps to achieve the high fracture toughness values described herein and provides protection against UV induced discoloration. In embodiments, the glass composition comprises ZnO in an amount from greater than or equal to 0 mol % to less than or equal to 3.5 mol %, such as greater than 0 mol % to less than or equal to 2.1 mol %, greater than or equal to 0 mol % to less than or equal to 0.5 mol %, greater than or equal to 0.2 mol % to less than or equal to 0.8 mol %, greater than or equal to 0.3 mol % to less than or equal to 0.7 mol %, greater than or equal to 0.4 mol % to less than or equal to 0.6 mol %, greater than or equal to 0.1 mol % to less than or equal to 0.5 mol %, from greater than or equal to 0 mol % to less than or equal to 0.3 mol %, and all ranges and sub-ranges between the foregoing values. In embodiments, the glass composition is substantially free or free of ZnO.

The glass compositions include Li₂O. The inclusion of Li₂O in the glass composition allows for better control of an ion exchange process and further reduces the softening point of the glass, thereby increasing the manufacturability of the glass. The presence of Li₂O in the glass compositions also allows the formation of a stress profile with a parabolic shape. The Li₂O in the glass compositions enables the high fracture toughness values described herein. In embodiments, the glass composition comprises Li₂O in an amount from greater than or equal to 7.4 mol % to less than or equal to 11.5 mol %, such as greater than or equal to 8.9 mol % to less than or equal to 11.0 mol %, greater than or equal to 9.0 mol % to less than or equal to 10.0 mol %, and all ranges and sub-ranges between the foregoing values.

The glass compositions described herein include Na₂O. Na₂O may aid in the ion-exchangeability of the glass composition, and improve the formability, and thereby manufacturability, of the glass composition. However, if too much Na₂O is added to the glass composition, the CTE may be too low, and the melting point may be too high. Additionally, if too much Na₂O is included in the glass relative to the amount of Li₂O the ability of the glass to achieve a deep depth of compression when ion exchanged may be reduced. In embodiments, the glass composition comprises Na₂O in an amount from greater than or equal to 0.4 mol % to less than or equal to 5.5 mol %, such as greater than or equal to 1.8 mol % to less than or equal to 4.3 mol %, greater than or equal to 3.0 mol % to less than or equal to 4.0 mol %, and all ranges and sub-ranges between the foregoing values.

The glass compositions may include K₂O. The inclusion of K₂O in the glass composition increases the potassium diffusivity in the glass, enabling a deeper depth of a compressive stress spike (DOL_{SP}) to be achieved in a shorter amount of ion exchange time. If too much K₂O is included in the composition the amount of compressive stress imparted during an ion-exchange process may be reduced. In embodiments, the glass composition comprises K₂O in an amount from greater than 0 mol % to less than or equal to 1.0 mol %, such as greater than or equal to 0.15 mol % to less than or equal to 0.25 mol %, and all ranges and sub-ranges between the foregoing values. In embodiments, the glass composition is substantially free or free of K₂O.

The glass compositions may include Y₂O₃. The inclusion of Y₂O₃ in the glass increases the solubility of ZrO₂. ZrO₂ has limited solubility and is particularly desirable for the compositions disclosed herein, so increasing the solubility is desirable. But, Y₂O₃ is expensive. In embodiments, the glass composition comprises Y₂O₃ in an amount from greater than 0 mol % to less than or equal to 2.5 mol %, such as greater than or equal to 0.1 mol % to less than or equal to 1 mol %, greater than or equal to 0.1 mol % to less than or equal to 0.5 mol %, and all ranges and sub-ranges between the foregoing values. In embodiments, the glass composition is substantially free or free of Y₂O₃.

The glass compositions may optionally include one or more fining agents. In embodiments, the fining agent may include, for example, SnO₂. In embodiments, SnO₂ may be present in the glass composition in an amount less than or equal to 0.2 mol %, such as from greater than or equal to 0 mol % to less than or equal to 0.2 mol %, greater than or equal to 0 mol % to less than or equal to 0.1 mol %, greater than or equal to 0 mol % to less than or equal to 0.05 mol %, greater than or equal to 0.1 mol % to less than or equal to 0.2 mol %, and all ranges and sub-ranges between the foregoing values. In some embodiments, the glass composition may be substantially free or free of SnO₂. In embodiments, the glass composition may be substantially free of one or both of arsenic and antimony. In other embodiments, the glass composition may be free of one or both of arsenic and antimony.

The glass compositions described herein may be formed primarily from SiO₂, Al₂O₃, B₂O₃, CaO, Li₂O, Na₂O, ZrO₂, and optionally MgO, ZnO and K₂O. In embodiments, the glass compositions are substantially free or free of components other than SiO₂, Al₂O₃, B₂O₃, CaO, Li₂O, Na₂O, ZrO₂, and optionally MgO, ZnO and K₂O in the amounts specified herein. In embodiments, the glass compositions are substantially free or free of components other than SiO₂, Al₂O₃, Li₂O, Na₂O, P₂O₅, B₂O₃, TiO₂, and a fining agent.

In embodiments, the glass composition may be substantially free or free of Fe₂O₃. Iron is often present in raw materials utilized to form glass compositions, and as a result may be detectable in the glass compositions described herein even when not actively added to the glass batch.

In embodiments, the glass composition may be substantially free or free of at least one of Ta₂O₅, HfO₂, La₂O₃, and Y₂O₃. In embodiments, the glass composition may be substantially free or free of Ta₂O₅, HfO₂, and La₂O₃. While these components may increase the fracture toughness of the glass when included, there are cost and supply constraints that make using these components undesirable for commercial purposes. Stated differently, the ability of the glass compositions described herein to achieve high fracture toughness values without the inclusion of Ta₂O₅, HfO₂, and La₂O₃ provides a cost and manufacturability advantage.

Physical properties of the glass compositions as disclosed above will now be discussed.

### Fracture Toughness

Glass compositions according to embodiments have a high fracture toughness. Without wishing to be bound by any particular theory, the high fracture toughness may impart improved drop performance to the glass compositions. The high fracture toughness of the glass compositions described herein increases the resistance of the glasses to damage and allows a higher degree of stress to be imparted to the glass through ion exchange, as characterized by central tension, without becoming frangible. As utilized herein, the fracture toughness refers to the K_{IC} value as measured by the chevron notched short bar method unless otherwise noted. The chevron notched short bar (CNSB) method utilized to measure the K_{IC} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). Additionally, the K_{IC} values are measured on non-strengthened glass samples, such as measuring the K_{IC} value prior to ion exchanging a glass-based substrate. The K_{IC} values discussed herein are reported in MPa√m, unless otherwise noted.

In embodiments, the glass compositions exhibit a K_{IC} value of greater than or equal to 0.7 MPa√m, such as greater than or equal to 0.75 MPa√m. In embodiments, the glass compositions exhibit a K_{IC} value of greater than or equal to 0.7 MPa√m and less than or equal to 0.9. In embodiments, greater than or equal to 0.77 MPa√m, greater than or equal to 0.8 MPa√m, or more. In embodiments, the glass compositions exhibit a K_{IC} value within all ranges and sub-ranges between the foregoing values.

### Liquidus Viscosity

The glass compositions described herein have liquidus viscosities that are compatible with manufacturing processes that are especially suitable for forming thin glass sheets. For example, the glass compositions are compatible with down draw processes such as fusion draw processes or slot draw processes. Embodiments of the glass-based substrates may be described as fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass-based substrate. The fusion of the glass films produces a fusion line within the glass-based substrate, and this fusion line allows glass-based substrates that were fusion formed to be identified without additional knowledge of the manufacturing history. The fusion draw method offers the advantage that, because the two glass films flowing over the channel fuse together, neither of the outside surfaces of the resulting glass-based substrate comes in contact with any part of the apparatus. Thus, the surface properties of the fusion drawn glass-based substrate are not affected by such contact.

The glass compositions described herein may be selected to have liquidus viscosities that are compatible with fusion draw processes. Thus, the glass compositions described herein are compatible with existing forming methods, increasing the manufacturability of glass-based substrates formed from the glass compositions. As used herein, the term “liquidus viscosity” refers to the viscosity of a molten glass at the liquidus temperature, wherein the liquidus temperature refers to the temperature at which crystals first appear as a molten glass cools down from the melting temperature, or the temperature at which the very last crystals melt away as temperature is increased from room temperature. Unless specified otherwise, a liquidus viscosity value disclosed in this application is determined by the following method. First, the liquidus temperature of the glass is measured in accordance with ASTM C829-81 (2015), titled “Standard Practice for Measurement of Liquidus Temperature of Glass by the Gradient Furnace Method.” Next, the viscosity of the glass at the liquidus temperature is measured in accordance with ASTM C965-96 (2012), titled “Standard Practice for Measuring Viscosity of Glass Above the Softening Point”. The term “Vogel-Fulcher-Tamman (‘VFT’) relation,” as used herein, described the temperature dependence of the viscosity and is represented by the following equation:

$$log η = A + \frac{B}{T - {T}_{o}}$$

where η is viscosity. To determine VFT A, VFT B, and VFT Tₒ, the viscosity of the glass composition is measured over a given temperature range. The raw data of viscosity versus temperature is then fit with the VFT equation by least-squares fitting to obtain A, B, and Tₒ. With these values, a viscosity point (e.g., 200 P Temperature, 35000 P Temperature, and 200000 P Temperature) at any temperature above softening point may be calculated. Unless otherwise specified, the liquidus viscosity and temperature of a glass composition or substrate is measured before the composition or substrate is subjected to any ion-exchange process or any other strengthening process. In particular, the liquidus viscosity and temperature of a glass composition or substrate is measured before the composition or substrate is exposed to an ion-exchange solution, for example before being immersed in an ion-exchange solution. Where an ion exchanged substrate is described as having a liquidus viscosity, the reference is to the liquidus viscosity of the substrate prior to ion exchange. The pre-ion exchange composition may be determined by looking at the composition at the center of the substrate.

In embodiments, the liquidus viscosity of the glass composition may be greater than or equal to 50 kP, such as greater than or equal to 55 kP, greater than or equal to 60 kP, greater than or equal to 65 kP, greater than or equal to 70 kP, greater than or equal to 75 kP, or more. In embodiments, the liquidus viscosity of the glass composition may be greater than or equal to 50 kP to less than or equal to 80 kP, such as greater than or equal to 55 kP to less than or equal to 75 kP, greater than or equal to 60 kP to less than or equal to 70 kP, greater than or equal to 50 kP to less than or equal to 65 kP, greater than or equal to 50 kP to less than or equal to 75 kP, and all ranges and sub-ranges between the foregoing values. A lower liquidus viscosity has been associated with higher K_{IC} values and improved ion exchange capability, but when the liquidus viscosity is too low the manufacturability of the glass compositions is reduced.

### Glass and Glass-Ceramic

In one or more embodiments, the glass compositions described herein may form glass-based substrates that exhibit an amorphous microstructure and may be substantially free of crystals or crystallites. In other words, the glass-based substrates formed from the glass compositions described herein may exclude glass-ceramic materials.

### Strengthened Glass

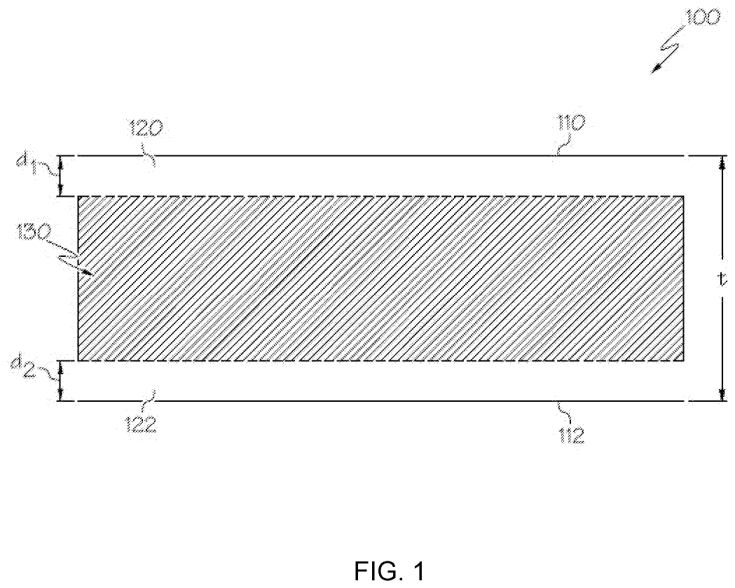

In embodiments, the glass compositions described herein can be strengthened, such as by ion exchange, making a glass-based substrate that is damage resistant for applications such as, but not limited to, display covers. With reference to FIG. 1, a glass-based substrate is depicted that has a first region under compressive stress (e.g., first and second compressive layers 120, 122 in FIG. 1) extending from the surface to a depth of compression (DOC) of the glass-based substrate and a second region (e.g., central region 130 in FIG. 1) under a tensile stress or central tension (CT) extending from the DOC into the central or interior region of the glass-based substrate. As used herein, DOC refers to the depth at which the stress within the glass-based substrate changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the glass-based substrate, and the CS varies with distance d from the surface according to a function. Referring again to FIG. 1, a first segment 120 extends from first surface 110 to a depth d₁ and a second segment 122 extends from second surface 112 to a depth d₂. Together, these segments define a compression or CS of glass-based substrate 100. Compressive stress (including surface CS) may be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

In embodiments, the CS of the glass-based substrates is from greater than or equal to 1000 MPa to less than or equal to 1500 MPa, such as greater than or equal to 1100 MPa to less than or equal to 1400 MPa, greater than or equal to 1200 MPa to less than or equal to 1300 MPa, and all ranges and sub-ranges between the foregoing values.

In embodiments, Na⁺ and K⁺ ions are exchanged into the glass-based substrate and the Na⁺ ions diffuse to a deeper depth into the glass-based substrate than the K⁺ ions. The depth of penetration of K⁺ ions (“Potassium DOL”) is distinguished from DOC because it represents the depth of potassium penetration as a result of an ion exchange process. The Potassium DOL is typically less than the DOC for the substrates described herein. Potassium DOL is measured using a surface stress meter such as the commercially available FSM-6000 surface stress meter, manufactured by Orihara Industrial Co., Ltd. (Japan), which relies on accurate measurement of the stress optical coefficient (SOC), as described above with reference to the CS measurement. The potassium DOL may define a depth of a compressive stress spike (DOL_{SP}), where a stress profile transitions from a steep spike region to a less-steep deep region. The deep region extends from the bottom of the spike to the depth of compression. The DOL_{SP} of the glass-based substrates may be from greater than or equal to 3 μm to less than or equal to 10 μm, such as greater than or equal to 4 μm to less than or equal to 9 μm, greater than or equal to 5 μm to less than or equal to 8 μm, greater than or equal to 6 μm to less than or equal to 7 μm, and all ranges and sub-ranges between the foregoing values.

The compressive stress of both major surfaces (110, 112 in FIG. 1) is balanced by stored tension in the central region (130) of the glass-based substrate. The maximum central tension (CT) and DOC values may be measured using a scattered light polariscope (SCALP) technique known in the art. The refracted near-field (RNF) method or SCALP may be used to determine the stress profile of the glass-based substrates. When the RNF method is utilized to measure the stress profile, the maximum CT value provided by SCALP is utilized in the RNF method. In particular, the stress profile determined by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-based substrate adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal.

The measurement of a maximum CT value is an indicator of the total amount of stress stored in the strengthened substrates, due to the force balancing described above. For this reason, the ability to achieve higher CT values correlates to the ability to achieve higher degrees of strengthening and increased performance. In embodiments, the glass-based substrates may have a maximum CT greater than or equal to 60 MPa, such as greater than or equal to 70 MPa, greater than or equal to 80 MPa, greater than or equal to 90 MPa, greater than or equal to 100 MPa, greater than or equal to 110 MPa, greater than or equal to 120 MPa, greater than or equal to 130 MPa, greater than or equal to 140 MPa, greater than or equal to 150 MPa, or more. In embodiments, the glass-based substrate may have a maximum CT of from greater than or equal to 60 MPa to less than or equal to 160 MPa, such as greater than or equal to 70 MPa to less than or equal to 160 MPa, greater than or equal to 80 MPa to less than or equal to 160 MPa, greater than or equal to 90 MPa to less than or equal to 160 MPa, greater than or equal to 100 MPa to less than or equal to 150 MPa, greater than or equal to 110 MPa to less than or equal to 140 MPa, greater than or equal to 120 MPa to less than or equal to 130 MPa, and all ranges and sub-ranges between the foregoing values.

The high fracture toughness values of the glass compositions described herein also may enable improved performance. The frangibility limit of the glass-based substrates produced utilizing the glass compositions described herein is dependent at least in part on the fracture toughness. For this reason, the high fracture toughness of the glass compositions described herein allows for a large amount of stored strain energy to be imparted to the glass-based substrates formed therefrom without becoming frangible. The increased amount of stored strain energy that may then be included in the glass-based substrates allows the glass-based substrates to exhibit increased fracture resistance, which may be observed through the drop performance of the glass-based substrates. The relationship between the frangibility limit and the fracture toughness is described in U.S. Patent Application Pub. No. 2020/0079689 A1, titled “Glass-based Articles with Improved Fracture Resistance,” published Mar. 12, 2020, the entirety of which is incorporated herein by reference. The relationship between the fracture toughness and drop performance is described in U.S. Patent Application Pub. No. 2019/0369672 A1, titled “Glass with Improved Drop Performance,” published Dec. 5, 2019, the entirety of which is incorporated herein by reference.

As noted above, DOC is measured using a scattered light polariscope (SCALP) technique known in the art. The DOC is provided in some embodiments herein as a portion of the thickness (t) of the glass-based substrate. In embodiments, the glass-based substrates may have a depth of compression (DOC) from greater than or equal to 0.20t to less than or equal to 0.25t, such as from greater than or equal to 0.21t to less than or equal to 0.24t, or from greater than or equal to 0.22t to less than or equal to 0.23t, and all ranges and sub-ranges between the foregoing values. The high DOC values produced when the glass compositions described herein are ion exchanged provide improved resistance to fracture, especially for situations where deep flaws may be introduced. For example, the deep DOC provides improved resistance to fracture when dropped on rough surfaces.

The ion-exchange conditions disclosed herein were not optimized for the glass compositions disclosed herein. As such, the data demonstrates that IOX is effective for these compositions and provides some examples of parameters that can be achieved. However, it is expected based on the disclosure herein that better parameters may be achieved, such as higher CT and CS.

### Thickness

Thickness (t) of glass-based substrate 100 is measured between surface 110 and surface 112. In embodiments, the thickness of glass-based substrate 100 may be in a range from greater than or equal to 0.1 mm to less than or equal to 4 mm, such as greater than or equal to 0.2 mm to less than or equal to 3.5 mm, greater than or equal to 0.3 mm to less than or equal to 3 mm, greater than or equal to 0.4 mm to less than or equal to 2.5 mm, greater than or equal to 0.5 mm to less than or equal to 2 mm, greater than or equal to 0.6 mm to less than or equal to 1.5 mm, greater than or equal to 0.7 mm to less than or equal to 1 mm, greater than or equal to 0.2 mm to less than or equal to 2 mm, and all ranges and sub-ranges between the foregoing values. The glass substrate utilized to form the glass-based substrate may have the same thickness as the thickness desired for the glass-based substrate.

### Ion Exchange

Compressive stress layers may be formed in the glass by exposing the glass to an ion exchange medium. In embodiments, the ion exchange medium may be molten nitrate salt. In embodiments, the ion exchange medium may be a molten salt bath, and may include KNO₃, NaNO₃, or combinations thereof. In embodiments, other sodium and potassium salts may be used in the ion exchange medium, such as, for example sodium or potassium nitrites, phosphates, or sulfates. In embodiments, the ion exchange medium may include lithium salts, such as LiNO₃. The ion exchange medium may additionally include additives commonly included when ion exchanging glass, such as silicic acid. The ion exchange process is applied to a glass-based substrate to form a glass-based substrate that includes a compressive stress layer extending from a surface of the glass-based substrate to a depth of compression and a central tension region. The glass-based substrate utilized in the ion exchange process may include any of the glass compositions described herein.

In embodiments, the ion exchange medium comprises NaNO₃. The sodium in the ion exchange medium exchanges with lithium ions in the glass to produce a compressive stress. In embodiments, the ion exchange medium may include NaNO₃ in an amount of less than or equal to 95 wt %, such as less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less. In embodiments, the ion exchange medium may include NaNO₃ in an amount of greater than or equal to 5 wt %, such as greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, or more. In embodiments, the ion exchange medium may include NaNO₃ in an amount of greater than or equal to 0 wt % to less than or equal to 100 wt %, such as greater than or equal to 10 wt % to less than or equal to 90 wt %, greater than or equal to 20 wt % to less than or equal to 80 wt %, greater than or equal to 30 wt % to less than or equal to 70 wt %, greater than or equal to 40 wt % to less than or equal to 60 wt %, greater than or equal to 50 wt % to less than or equal to 90 wt %, and all ranges and sub-ranges between the foregoing values. In embodiments, the molten ion exchange medium includes 100 wt % NaNO₃.

In embodiments, the ion exchange medium comprises KNO₃. In embodiments, the ion exchange medium may include KNO₃ in an amount of less than or equal to 95 wt %, such as less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 10 wt %, or less. In embodiments, the ion exchange medium may include KNO₃ in an amount of greater than or equal to 5 wt %, such as greater than or equal to 10 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, greater than or equal to 90 wt %, or more. In embodiments, the ion exchange medium may include KNO₃ in an amount of greater than or equal to 0 wt % to less than or equal to 100 wt %, such as greater than or equal to 10 wt % to less than or equal to 90 wt %, greater than or equal to 20 wt % to less than or equal to 80 wt %, greater than or equal to 30 wt % to less than or equal to 70 wt %, greater than or equal to 40 wt % to less than or equal to 60 wt %, greater than or equal to 50 wt % to less than or equal to 90 wt %, and all ranges and sub-ranges between the foregoing values. In embodiments, the molten ion exchange medium includes 100 wt % KNO₃.

The ion exchange medium may include a mixture of sodium and potassium. In embodiments, the ion exchange medium is a mixture of potassium and sodium, such as a molten salt bath that includes both NaNO₃ and KNO₃. In embodiments, the ion exchange medium may include any combination NaNO₃ and KNO₃ in the amounts described above, such as a molten salt bath containing 80 wt % NaNO₃ and 20 wt % KNO₃.

The glass composition may be exposed to the ion exchange medium by dipping a glass substrate made from the glass composition into a bath of the ion exchange medium, spraying the ion exchange medium onto a glass substrate made from the glass composition, or otherwise physically applying the ion exchange medium to a glass substrate made from the glass composition to form the ion exchanged glass-based substrate. Upon exposure to the glass composition, the ion exchange medium may, according to embodiments, be at a temperature from greater than or equal to 360° C. to less than or equal to 500° C., such as greater than or equal to 370° C. to less than or equal to 490° C., greater than or equal to 380° C. to less than or equal to 480° C., greater than or equal to 390° C. to less than or equal to 470° C., greater than or equal to 400° C. to less than or equal to 460° C., greater than or equal to 410° C. to less than or equal to 450° C., greater than or equal to 420° C. to less than or equal to 440° C., greater than or equal to 430° C. to less than or equal to 470° C., greater than or equal to 400° C. to less than or equal to 470° C., greater than or equal to 380° C. to less than or equal to 470° C., and all ranges and sub-ranges between the foregoing values. In embodiments, the glass composition may be exposed to the ion exchange medium for a duration from greater than or equal to 10 minutes to less than or equal to 48 hours, such as greater than or equal to 10 minutes to less than or equal to 24 hours, greater than or equal to 0.5 hours to less than or equal to 24 hours, greater than or equal to 1 hours to less than or equal to 18 hours, greater than or equal to 2 hours to less than or equal to 12 hours, greater than or equal to 4 hours to less than or equal to 8 hours, and all ranges and sub-ranges between the foregoing values.

The ion exchange process may include a second ion exchange treatment. In embodiments, the second ion exchange treatment may include ion exchanging the glass-based substrate in a second molten salt bath. The second ion exchange treatment may utilize any of the ion exchange mediums described herein. In embodiments, the second ion exchange treatment utilizes a second molten salt bath that includes KNO₃.

The ion exchange process may be performed in an ion exchange medium under processing conditions that provide an improved compressive stress profile as disclosed, for example, in U.S. Patent Application Publication No. 2016/0102011, which is incorporated herein by reference in its entirety. In some embodiments, the ion exchange process may be selected to form a parabolic stress profile in the glass-based substrates, such as those stress profiles described in U.S. Patent Application Publication No. 2016/0102014, which is incorporated herein by reference in its entirety.

After an ion exchange process is performed, it should be understood that a composition at the surface of an ion exchanged glass-based substrate is be different than the composition of the pre-IOX glass substrate (i.e., the glass substrate before it undergoes an ion exchange process). This results from one type of alkali metal ion in the as-formed glass substrate, such as, for example Li⁺ or Na⁺, being replaced with larger alkali metal ions, such as, for example Na⁺ or K⁺, respectively. However, the glass composition at or near the center of the depth of the ion exchanged glass-based substrate will, in embodiments, still have the composition of the as-formed non-ion exchanged glass substrate. As utilized herein, the center of the glass-based substrate refers to any location in the glass-based substrate that is a distance of at least 0.5t from every surface thereof, where t is the thickness of the glass-based substrate.

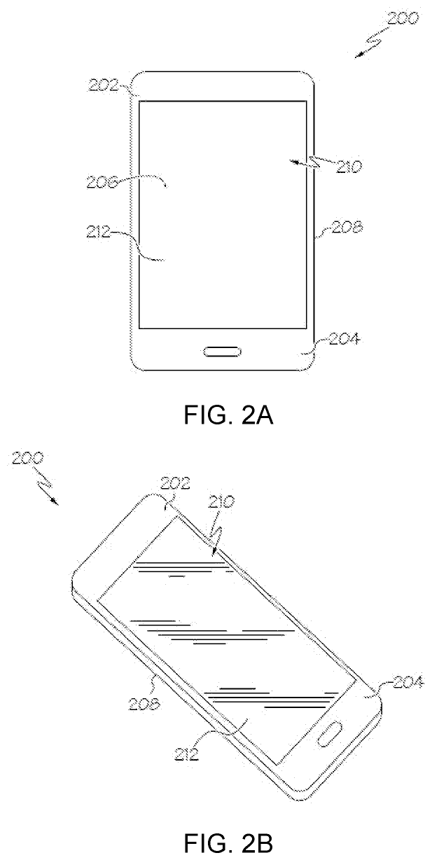

The glass-based substrates disclosed herein may be incorporated into an article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the glass-based articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover 212 at or over the front surface of the housing such that it is over the display. In embodiments, at least a portion of at least one of the cover 212 and the housing 202 may include any of the glass-based articles described herein.

### Examples

Embodiments will be further clarified by the following examples. It should be understood that these examples are not limiting to the embodiments described above.

Glass compositions were prepared and analyzed. The analyzed glass compositions for Samples 1 through 45 included the components listed in Tables 1-8 below and were prepared by conventional glass forming methods. In Tables 1-8, all components are in mol %, and the K_{IC} fracture toughness was measured primarily with the chevron notch (CNSB) method described herein. The Poisson's ratio (ν), the Young's modulus (E), and the shear modulus (G) of the glass compositions were measured by a resonant ultrasonic spectroscopy technique of the general type set forth in ASTM E2001-13, titled “Standard Guide for Resonant Ultrasound Spectroscopy for Defect Detection in Both Metallic and Non-metallic Parts.”. The refractive index at 589.3 nm and stress optical coefficient (SOC) of the substrates are also reported in Tables 1-8. The density of the glass compositions was determined using the buoyancy method of ASTM C693-93(2013).

The term “annealing point,” as used herein, refers to the temperature at which the viscosity of the glass composition is 1×10^{13.18} poise. The term “strain point,” as used herein, refers to the temperature at which the viscosity of the glass composition is 1×10^{14.68} poise. The strain point and annealing point of the glass compositions was determined using the fiber elongation method of ASTM C336-71(2015) or the beam bending viscosity (BBV) method of ASTM C598-93(2013).

The term “softening point,” as used herein, refers to the temperature at which the viscosity of the glass composition is 1×10^{7.6} poise. The softening point of the glass compositions was determined using the fiber elongation method of ASTM C336-71(2015) or a parallel plate viscosity (PPV) method which measures the viscosity of inorganic glass from 10⁷ to 10⁹ poise as a function of temperature, similar to ASTM C1351M.

The linear coefficient of thermal expansion (CTE) over the temperature range 0-300° C. is expressed in terms of ppm/° C. and was determined using a push-rod dilatometer in accordance with ASTM E228-11.

Both before and after ion exchange, every sample was visually observed to have a transparency suitable for the cover glass of an electronic display, such as the electronic display of a cell phone.

TABLE 1

| analyzed mol % | 1 | 2 | 3 | 4 | 5 | 6 |
|---|---|---|---|---|---|---|
| SiO2 | 59.69 | 59.77 | 59.83 | 59.62 | 58.73 | 57.98 |
| Al2O3 | 18.02 | 17.96 | 17.88 | 17.95 | 17.93 | 17.89 |
| B2O3 (ICP) | 4.11 | 4.05 | 4.06 | 4.06 | 4.05 | 3.97 |
| MgO | 3.90 | 2.90 | 1.93 | 3.87 | 4.36 | 4.80 |
| CaO | 1.98 | 1.97 | 1.96 | 1.98 | 1.97 | 1.97 |
| SrO | | | | | | |
| ZnO | | | | | | |
| Li2O | 9.43 | 9.53 | 9.52 | 9.47 | 9.41 | 9.35 |
| Na2O | 2.34 | 3.30 | 4.28 | 2.33 | 2.82 | 3.30 |
| K2O | 0.20 | 0.20 | 0.20 | 0.20 | 0.20 | 0.20 |
| ZrO2 | 0.31 | 0.31 | 0.32 | 0.51 | 0.52 | 0.52 |
| Y2O3 | | | | | | |
| Sum | 100.00 | 100.00 | 100.00 | 100.00 | 100.00 | 100.0 |
| Properties | | | | | | |
| Density | 2.445 | 2.438 | 2.435 | 2.451 | 2.457 | 2.464 |
| Strain PT (BBV) (10\hat{ }14.68 P) | 588.9 | 575 | 572.6 | 589.1 | 577.5 | 572.1 |
| Annealing PT (BBV) (10\hat{ }13.18 P) | 634.5 | 621.7 | 618.7 | 634 | 623.1 | 616.4 |
| Soft PT (PPV) (10\hat{ }7.6 P) | 845.6 | 833.2 | 838 | 843 | 831.6 | 814.2 |
| Young's modulus (GPa) | 85.4 | 84.3 | 83.1 | 85.6 | 85.8 | 86.3 |
| Shear's modulus (GPa) | 34.7 | 34.3 | 33.8 | 34.8 | 34.8 | 34.9 |
| Poisson's ratio | 0.231 | 0.230 | 0.229 | 0.230 | 0.231 | 0.237 |
| K1C (CN) | 0.814 | 0.798 | 0.789 | 0.818 | 0.822 | 0.808 |
| STDEV(CN) | 0.007 | 0.007 | 0.011 | 0.005 | 0.015 | 0.012 |
| RI @ 589.3 | 1.5262 | 1.5243 | 1.5224 | 1.5273 | 1.5282 | 1.5291 |
| SOC (546.1 nm) single PT | 2.899 | 2.927 | 2.957 | 2.898 | 2.855 | 2.857 |
| VFT parameters from HTV | | | | | | |
| A | −2.685 | −2.100 | −2.695 | −2.638 | −2.203 | −2.765 |
| B | 5907.4 | 4994.1 | 6129.4 | 5782.1 | 5012.2 | 5952.6 |
| To | 265.3 | 337.1 | 242.2 | 275.9 | 327.8 | 241.3 |
| Liquidus (gradient boat) | | | | | | |
| duration (hours) | 24 | 24 | 24 | 24 | 24 | 24 |
| Air (° C.) | 1285 | 1215 | 1145 | 1235 | 1205 | 1215 |
| internal (° C.) | 1270 | 1215 | 1185 | 1230 | 1215 | 1200 |
| Pt (° C.) | 1260 | 1215 | 1175 | 1235 | 1215 | 1200 |
| primary phase | Corundum | Corundum | Corundum | Corundum | Spinel | Spinel |
| 2ndry phase | | | Spodumene | | Corundum | |
| tertiary phase | | | | | | |
| liquidus viscosity (Internal) Poise | 1566 | 3879 | 6401 | 2644 | 2795 | 2780 |

TABLE 2

| analyzed mol % | 7 | 8 | 9 | 10 | 11 | 12 |
|---|---|---|---|---|---|---|
| SiO2 | 58.66 | 58.26 | 57.16 | 58.64 | 57.84 | 56.89 |
| Al2O3 | 17.58 | 18.11 | 18.82 | 17.84 | 18.21 | 18.71 |
| B2O3 (ICP) | 4.03 | 4.04 | 4.07 | 4.02 | 4.04 | 4.08 |
| MgO | 3.87 | 4.26 | 4.44 | 3.96 | 4.33 | 4.41 |
| CaO | 2.00 | 2.01 | 2.05 | 2.00 | 2.03 | 2.03 |
| SrO | | | | | | |
| ZnO | | | | | | |
| Li2O | 10.05 | 9.50 | 9.65 | 9.52 | 9.49 | 9.82 |
| Na2O | 2.83 | 2.83 | 2.86 | 2.84 | 2.83 | 2.83 |
| K2O | 0.20 | 0.20 | 0.20 | 0.20 | 0.20 | 0.20 |
| ZrO2 | 0.76 | 0.77 | 0.75 | 0.97 | 1.01 | 1.01 |
| Y2O3 | | | | | | |
| Sum | 100.00 | 100.00 | 100.00 | 100.00 | 100.00 | 100.00 |
| Properties | | | | | | |
| Density | 2.459 | 2.465 | 2.469 | 2.465 | 2.471 | 2.477 |
| Strain PT (BBV) (10\hat{ }14.68 P) | 573.9 | 573 | 571.6 | 575.2 | 575.7 | 571.5 |
| Annealing PT (BBV) (10\hat{ }13.18 P) | 618.7 | 618.3 | 615.7 | 619.7 | 620.3 | 615.9 |
| Soft PT (PPV) (10\hat{ }7.6 P) | 827.6 | 823.1 | 817.7 | 824.6 | 819.4 | 819.6 |
| Young's modulus (GPa) | 84.1 | 86.3 | 86.7 | 85.8 | 86.3 | 86.9 |
| Shear's modulus (GPa) | 34.5 | 35.0 | 35.1 | 34.8 | 35.0 | 35.2 |
| Poisson's ratio | 0.218 | 0.234 | 0.236 | 0.232 | 0.233 | 0.236 |
| K1C (CN) | 0.831 | 0.815 | 0.849 | 0.837 | 0.783 | 0.829 |
| STDEV(CN) | 0.006 | 0.020 | 0.014 | 0.004 | 0.021 | 0.023 |
| RI @ 589.3 | 1.5284 | 1.5308 | 1.5317 | 1.5304 | 1.5321 | 1.5334 |
| SOC (546.1 nm) single PT | 2.892 | 2.862 | 2.838 | 2.878 | 2.897 | 2.844 |
| VFT parameters from HTV | | | | | | |
| A | −2.175 | −2.615 | −2.536 | −2.169 | −2.358 | −2.049 |
| B | 4990.2 | 5715.0 | 5473.7 | 4965.7 | 5197.4 | 4540.7 |
| To | 323.4 | 256.5 | 273.9 | 327.2 | 300.7 | 362.8 |
| Liquidus (gradient boat) | | | | | | |
| duration (hours) | 24 | 24 | 24 | 24 | 24 | 24 |
| Air (° C.) | 1280 | 1300 | 1270 | >1315 | >1275 | 1315 |
| internal (° C.) | 1230 | 1230 | 1270 | >1315 | >1275 | 1310 |
| Pt (° C.) | 1215 | 1220 | 1250 | >1315 | >1275 | 1280 |
| primary phase | Zirconia | Zirconia | Zirconia | Zirconia | Zirconia | Zirconia |
| 2ndry phase | | Spinel | Spinel | | | |
| tertiary phase | | | | | | |
| liquidus viscosity (Internal) Poise | 2135 | 1801 | 910 | <721 | <400 | 556 |

TABLE 3

| analyzed mol % | 13 | 14 | 15 | 16 | 17 | 18 |
|---|---|---|---|---|---|---|
| SiO2 | 55.20 | 55.71 | 54.06 | 53.76 | 53.53 | 51.98 |
| Al2O3 | 18.31 | 18.13 | 18.53 | 18.04 | 17.92 | 18.57 |
| B2O3 (ICP) | 6.21 | 6.02 | 6.09 | 7.97 | 8.09 | 8.02 |
| MgO | 4.47 | 4.39 | 4.36 | 4.37 | 4.33 | 4.39 |
| CaO | 2.03 | 2.00 | 1.98 | 1.99 | 1.98 | 2.00 |
| SrO | | | | | | |
| ZnO | | | | | | |
| Li2O | 9.98 | 9.66 | 10.93 | 10.08 | 10.10 | 10.99 |
| Na2O | 2.82 | 2.83 | 2.80 | 2.80 | 2.80 | 2.80 |
| K2O | 0.20 | 0.20 | 0.20 | 0.20 | 0.20 | 0.20 |
| ZrO2 | 0.77 | 1.04 | 1.04 | 0.79 | 1.04 | 1.04 |
| Y2O3 | | | | | | |
| Sum | 100.00 | 100.00 | 100.00 | 100.00 | 100.00 | 100.00 |
| Properties | | | | | | |
| Density | 2.457 | 2.465 | 2.469 | 2.448 | 2.455 | 2.461 |
| Strain PT (BBV) (10\hat{ }14.68 P) | 559.4 | 556.9 | 549.4 | 545 | 545.5 | 538.6 |
| Annealing PT (BBV) (10\hat{ }13.18 P) | 603 | 601.1 | 592.4 | 587.6 | 588.7 | 580.6 |
| Soft PT (PPV) (10\hat{ }7.6 P) | 798.7 | 797.9 | 786.7 | 775.1 | 778.8 | 768 |
| Young's modulus (GPa) | 84.7 | 85.2 | 85.6 | 83.1 | 83.4 | 84.1 |
| Shear's modulus (GPa) | 34.3 | 34.4 | 34.5 | 33.5 | 33.7 | 33.9 |
| Poisson's ratio | 0.236 | 0.237 | 0.239 | 0.239 | 0.238 | 0.242 |
| K1C (CN) | 0.799 | 0.860 | 0.799 | 0.812 | 0.825 | 0.812 |
| STDEV(CN) | 0.007 | 0.086 | 0.012 | 0.003 | 0.010 | 0.010 |
| RI @ 589.3 | 1.5310 | 1.5332 | 1.5348 | 1.5309 | 1.5323 | 1.5345 |
| SOC (546.1 nm) single PT | 2.948 | 2.908 | 2.884 | 2.970 | 2.975 | 2.975 |
| VFT parameters from HTV | | | | | | |
| A | −2.223 | −1.462 | −1.953 | −2.198 | −2.006 | −1.601 |
| B | 4856.9 | 3513.6 | 4238.8 | 4738.9 | 4384.8 | 3557.5 |
| To | 306.3 | 447.8 | 362.0 | 293.1 | 331.6 | 409.7 |
| Liquidus (gradient boat) | | | | | | |
| duration (hours) | 24 | 24 | 24 | 24 | 24 | 24 |
| Air (° C.) | 1270 | >1295 | >1300 | 1305 | 1320 | 1315 |
| internal (° C.) | 1265 | >1295 | >1300 | 1250 | 1320 | 1305 |
| Pt (° C.) | 1215 | >1295 | >1300 | 1195 | 1285 | 1255 |
| primary phase | Zirconia | Zirconia | Zirconia | Zirconia | Zirconia | Zirconia |
| 2ndry phase | | | | | | |
| tertiary phase | | | | | | |
| liquidus viscosity (Internal) Poise | 697 | <485 | <368 | 568 | 269 | 236 |

TABLE 4

| analyzed mol % | 19 | 20 | 21 | 22 | 23 | 24 |
|---|---|---|---|---|---|---|
| SiO2 | 58.67 | 58.80 | 58.74 | 58.24 | 56.24 | 54.26 |
| Al2O3 | 18.03 | 18.03 | 18.01 | 18.02 | 18.02 | 18.03 |
| B2O3 (ICP) | 3.98 | 3.85 | 3.90 | 3.90 | 5.86 | 7.82 |
| MgO | 1.94 | 1.94 | 1.93 | 1.94 | 1.95 | 1.94 |
| CaO | 2.95 | 3.94 | 4.94 | 3.95 | 3.96 | 3.97 |
| Li2O | 9.92 | 9.90 | 9.90 | 9.90 | 9.92 | 9.94 |
| Na2O | 3.79 | 2.82 | 1.84 | 2.81 | 2.81 | 2.79 |
| K2O | 0.20 | 0.20 | 0.20 | 0.20 | 0.20 | 0.19 |
| ZrO2 | 0.52 | 0.52 | 0.52 | 1.03 | 1.03 | 1.04 |
| Y2O3 | | | | | | |
| Sum | 100.00 | 100.00 | 100.00 | 100.00 | 100.00 | 100.00 |
| Properties | | | | | | |
| Density | 2.451 | 2.460 | 2.461 | 2.474 | 2.466 | 2.457 |
| Strain PT (BBV) (10\hat{ }14.68 P) | 570.1 | 578.8 | 588 | 581.5 | 564.9 | 551.5 |
| Annealing PT (BBV) (10\hat{ }13.18 P) | 616 | 623.8 | 632.8 | 626.8 | 609.3 | 594.6 |
| Soft PT (PPV) (10\hat{ }7.6 P) | 829.5 | 830.6 | 833.5 | 831.1 | 808.2 | 787.7 |
| Young's modulus (GPa) | 84.0 | 84.8 | 85.7 | 85.5 | 83.8 | 82.4 |
| Shear's modulus (GPa) | 34.1 | 34.5 | 34.8 | 34.7 | 33.9 | 33.3 |
| Poisson's ratio | 0.229 | 0.230 | 0.231 | 0.232 | 0.236 | 0.238 |
| K1C (CN) | 0.782 | 0.801 | 0.805 | 0.791 | 0.788 | 0.797 |
| STDEV(CN) | 0.007 | 0.016 | 0.005 | 0.002 | 0.011 | 0.003 |
| RI @ 589.3 | 1.5269 | 1.5296 | 1.5322 | 1.5326 | 1.5321 | 1.5322 |
| SOC (546.1 nm) single PT | 2.905 | 2.871 | 2.838 | 2.888 | 2.913 | 2.972 |
| VFT parameters from HTV | | | | | | |
| A | −2.450 | −2.487 | −2.383 | −2.094 | −1.639 | −2.348 |
| B | 5610.3 | 5564.3 | 5256.0 | 4733.5 | 3824.4 | 4991.8 |
| To | 271.4 | 271.6 | 310.0 | 357.8 | 415.9 | 286.0 |
| Liquidus (gradient boat) | | | | | | |
| duration (hours) | 24 | 24 | 24 | 24 | 24 | 24 |
| Air (° C.) | 1155 | 1195 | 1220 | >1345 | >1335 | 1370 |
| internal (° C.) | 1120 | 1155 | 1205 | >1345 | >1335 | 1365 |
| Pt (° C.) | 1125 | 1165 | 1185 | >1345 | >1335 | 1330 |
| primary phase | Spodumene | Spodumene | Spodumene | Zirconia | Zirconia | Zirconia |
| 2ndry phase | Zircon | | | | | |
| tertiary phase | | | | | | |
| liquidus viscosity (Internal) Poise | 14496 | 6482 | 3088 | <502 | <333 | 190 |

TABLE 5

| analyzed mol % | 25 | 26 | 27 | 28 | 29 | 30 |
|---|---|---|---|---|---|---|
| SiO2 | 58.48 | 58.49 | 56.28 | 56.35 | 58.66 | 58.81 |
| Al2O3 | 18.03 | 18.05 | 18.09 | 18.08 | 18.04 | 18.04 |
| B2O3 (ICP) | 4.07 | 3.96 | 4.05 | 4.04 | 3.82 | 3.98 |
| MgO | 3.37 | 2.40 | 4.35 | 3.39 | 3.38 | 2.41 |
| CaO | 1.98 | 1.99 | 2.00 | 1.99 | 2.00 | 2.00 |
| SrO | | | | | | |
| ZnO | 1.01 | 2.02 | 1.01 | 2.02 | 1.00 | 2.00 |
| Li2O | 9.26 | 9.27 | 9.43 | 9.33 | 9.30 | 8.98 |
| Na2O | 2.81 | 2.84 | 3.80 | 3.81 | 2.82 | 2.82 |
| K2O | 0.20 | 0.20 | 0.20 | 0.20 | 0.20 | 0.20 |
| ZrO2 | 0.77 | 0.76 | 0.76 | 0.76 | 0.76 | 0.75 |
| Y2O3 | | | | | | |
| Sum | 100.00 | 100.00 | 100.00 | 100.00 | 100.00 | 100.00 |
| Properties | | | | | | |
| Density | 2.479 | 2.492 | 2.491 | 2.504 | 2.479 | 2.491 |
| Strain PT (BBV) (10\hat{ }14.68 P) | 576.8 | 575.5 | 561.5 | 558.9 | 580.1 | 573.5 |
| Annealing PT (BBV) (10\hat{ }13.18 P) | 621.6 | 621.2 | 605.1 | 602.7 | 626.1 | 618.4 |
| Soft PT (PPV) (10\hat{ }7.6 P) | 830.3 | 826.6 | 804.9 | 804.6 | 837.1 | 831.8 |
| Young's modulus (GPa) | 86.1 | 85.9 | 86.3 | 86.3 | 86.0 | 85.8 |
| Shear's modulus (GPa) | 35.0 | 34.8 | 35.0 | 35.0 | 34.9 | 34.8 |
| Poisson's ratio | 0.230 | 0.235 | 0.233 | 0.235 | 0.234 | 0.233 |
| K1C (CN) | 0.844 | 0.873 | 0.813 | 0.813 | 0.792 | — |
| STDEV(CN) | 0.039 | 0.044 | 0.019 | 0.006 | 0.023 | — |
| RI @ 589.3 | 1.5316 | 1.5316 | 1.5330 | 1.5342 | 1.5304 | 1.5315 |
| SOC (546.1 nm) single PT | 2.939 | 2.940 | 2.880 | 2.918 | 2.923 | 2.974 |
| VFT parameters from HTV | | | | | | |
| A | −2.515 | −1.801 | −2.571 | −2.328 | −2.456 | −2.770 |
| B | 5523.7 | 4249.1 | 5536.0 | 5108.7 | 5354.7 | 6003.4 |
| To | 281.8 | 393.3 | 259.2 | 292.9 | 305.7 | 249.7 |
| Liquidus (gradient boat) | | | | | | |
| duration (hours) | 24 | 24 | 24 | 24 | 24 | 24 |
| Air (° C.) | >1300 | 1355 | 1325 | 1365 | 1330 | >1350 |
| internal (° C.) | >1300 | 1355 | 1325 | 1365 | 1325 | 1335 |
| Pt (° C.) | >1300 | 1325 | 1325 | 1310 | 1290 | 1330 |
| primary phase | Spinel | Spinel | Spinel | Spinel | Spinel | Spinel |
| 2ndry phase | | | | | | |
| tertiary phase | | | | | | |
| liquidus viscosity (Internal) Poise | <813 | 414 | 420 | 274 | 627 | 578 |

TABLE 6

| analyzed mol % | 31 | 32 | 33 | 34 | 35 | 36 |
|---|---|---|---|---|---|---|
| SiO2 | 57.48 | 57.79 | 57.64 | 58.49 | 58.15 | 56.60 |
| Al2O3 | 18.07 | 18.13 | 18.11 | 17.92 | 18.00 | 18.04 |
| B2O3 (ICP) | 4.08 | 4.13 | 4.05 | 4.05 | 4.12 | 4.04 |
| MgO | 4.35 | 4.37 | 4.37 | 1.91 | 1.92 | 2.89 |
| CaO | 2.01 | 2.01 | 2.02 | 1.97 | 1.99 | 2.00 |
| SrO | | | | | | |
| ZnO | | | | | | 1.01 |
| Li2O | 9.43 | 8.98 | 8.98 | 9.63 | 9.53 | 9.39 |
| Na2O | 2.82 | 2.82 | 2.82 | 4.26 | 4.26 | 4.27 |
| K2O | 0.20 | 0.20 | 0.20 | 0.20 | 0.20 | 0.20 |
| ZrO2 | 0.55 | 0.55 | 0.79 | 0.56 | 0.80 | 0.57 |
| Y2O3 | 1.00 | 1.01 | 1.00 | 0.99 | 0.99 | 1.00 |
| Sum | 100.00 | 100.00 | 100.00 | 100.00 | 100.00 | 100.00 |
| Properties | | | | | | |
| Density | 2.516 | 2.515 | 2.514 | 2.499 | 2.507 | 2.532 |
| Strain PT (BBV) (10\hat{ }14.68 P) | 582.5 | 585.7 | 586.8 | 579 | 579.9 | 568 |
| Annealing PT (BBV) (10\hat{ }13.18 P) | 626 | 630.7 | 631 | 623.8 | 625.8 | 611.5. |
| Soft PT (PPV) (10\hat{ }7.6 P) | 824.4 | 833.7 | 832.2 | 831.8 | 829.8 | 808.9 |
| Young's modulus (GPa) | 87.8 | 87.6 | 88.1 | 85.0 | 85.4 | 87.0 |
| Shear's modulus (GPa) | 35.5 | 35.4 | 35.6 | 34.6 | 34.7 | 35.2 |
| Poisson's ratio | 0.236 | 0.236 | 0.237 | 0.227 | 0.233 | 0.238 |
| K1C (CN) | 0.889 | 0.837 | 0.849 | 0.809 | 0.824 | 0.808 |
| STDEV(CN) | 0.020 | 0.018 | 0.010 | — | 0.030 | 0.013 |
| RI @ 589.3 | 1.5377 | 1.5374 | 1.5388 | 1.5334 | 1.5345 | 1.5388 |
| SOC (546.1 nm) single PT | 2.825 | 2.801 | 2.829 | 2.886 | 2.886 | 2.837 |
| VFT parameters from HTV | | | | | | |
| A | −2.362 | −2.198 | −2.576 | −2.602 | −2.325 | −2.184 |
| B | 4992.4 | 4773.2 | 5354.0 | 5795.0 | 5099.1 | 4803.3 |
| To | 325.1 | 349.5 | 304.1 | 249.8 | 319.7 | 321.7 |
| Liquidus (gradient boat) | | | | | | |
| duration (hours) | 24 | 24 | 24 | 24 | 24 | 24 |
| Air (° C.) | 1235 | 1250 | 1245 | 1140 | 1280 | 1260 |
| internal (° C.) | 1175 | 1195 | 1215 | 1115 | 1240 | 1235 |
| Pt (° C.) | 1165 | 1190 | 1200 | 1115 | 1230 | 1205 |
| primary phase | Spinel | Corundum | Zircon | Spodumene | Spinel | Spinel |
| 2ndry phase | | Spinel | Spinel | Corundum | | |
| tertiary phase | | | Corundum | | | |
| liquidus viscosity (Internal) Poise | 3252 | 2802 | 2003 | 12470 | 1643 | 1189 |

TABLE 7

| analyzed mol % | 37 | 38 | 39 | 40 | 41 | 42 |
|---|---|---|---|---|---|---|
| SiO2 | 57.58 | 57.13 | 57.77 | 57.46 | 59.54 | 59.86 |
| Al2O3 | 18.78 | 18.29 | 18.67 | 18.76 | 17.79 | 17.62 |
| B2O3 (ICP) | 4.00 | 4.00 | 3.92 | 4.08 | 4.07 | 4.00 |
| MgO | 3.00 | 1.44 | 0.08 | 1.00 | 3.00 | 1.96 |
| CaO | 3.04 | 4.49 | 6.03 | 4.04 | 1.01 | 1.99 |
| SrO | | | | | | |
| ZnO | | | | 1.02 | 1.04 | 1.02 |
| Li2O | 9.59 | 10.70 | 9.50 | 9.63 | 9.53 | 9.53 |
| Na2O | 3.29 | 3.25 | 3.31 | 3.30 | 3.31 | 3.30 |
| K2O | 0.20 | 0.20 | 0.20 | 0.20 | 0.20 | 0.20 |
| ZrO2 | 0.51 | 0.51 | 0.51 | 0.50 | 0.50 | 0.51 |
| Y2O3 | | | | | | |
| Sum | 100.00 | 100.00 | 100.00 | 100.00 | 100.00 | 100.00 |
| Properties | | | | | | |
| Density | 2.461 | 2.464 | 2.470 | 2.479 | 2.454 | 2.457 |
| Strain PT (BBV) (10\hat{ }14.68 P) | 585.2 | 577.6 | 583 | 574.7 | 572.3 | 570.4 |
| Annealing PT (BBV) (10\hat{ }13.18 P) | 629.7 | 622.3 | 628.2 | 619.8 | 618.3 | 616.8 |
| Soft PT (PPV) (10\hat{ }7.6 P) | 828.4 | 830.2 | 830.4 | 826.6 | 835.1 | 834.6 |
| Young's modulus (GPa) | 85.2 | 84.8 | 84.2 | 84.9 | 84.3 | 84.0 |
| Shear's modulus (GPa) | 34.5 | 34.4 | 34.3 | 34.5 | 34.2 | 34.1 |
| Passion's ratio | 0.232 | 0.232 | 0.229 | 0.233 | 0.231 | 0.230 |
| K1C (CN) | 0.802 | — | 0.810 | 0.816 | 0.765 | 0.803 |
| STDEV(CN) | 0.018 | — | 0.009 | 0.005 | 0.006 | 0.014 |
| RI @ 589.3 | 1.5290 | 1.5303 | 1.5318 | 1.5309 | 1.5249 | 1.5263 |
| SOC (546.1 nm) single PT | 2.867 | 2.856 | 2.840 | 2.880 | 2.943 | 2.937 |
| VFT parameters from HTV | | | | | | |
| A | −2.496 | −2.374 | −2.593 | −2.435 | −2.678 | −2.710 |
| B | 5485.0 | 5360.5 | 5733.3 | 5540.5 | 6076.3 | 6134.0 |
| To | 288.6 | 297.5 | 265.7 | 272.9 | 241.4 | 237.1 |
| Liquidus (gradient boat) | | | | | | |
| duration (hours) | 24 | 24 | 24 | 24 | 24 | 24 |
| Air (° C.) | 1280 | 1195 | 1195 | 1295 | 1335 | 1290 |
| internal (° C.) | 1245 | 1170 | 1190 | 1245 | 1325 | 1265 |
| Pt (° C.) | 1210 | 1150 | 1180 | 1225 | 1315 | 1230 |
| primary phase | Corundum | Corundum | Anorthite | Spinel | Spinel | Spinel |
| 2ndry phase | | | | | | |
| tertiary phase | | | | | | |
| liquidus viscosity (Internal) Poise | 1734 | 5886 | 4072 | 1839 | 850 | 1809 |

TABLE 8

| analyzed mol % | 43 | 44 | 45 |
|---|---|---|---|
| SiO2 | 58.85 | 59.04 | 58.15 |
| Al2O3 | 18.15 | 17.98 | 18.03 |
| B2O3 (ICP) | 4.00 | 4.07 | 4.05 |
| MgO | 1.90 | 4.19 | 4.17 |
| CaO | 3.42 | 1.97 | 2.00 |
| SrO | | | |
| ZnO | | | |
| Li2O | 9.35 | 9.34 | 8.95 |
| Na2O | 3.59 | 2.66 | 2.64 |
| K2O | 0.20 | 0.20 | 0.20 |
| TiO2 | | 0.01 | 0.01 |
| Fe2O3 | 0.01 | 0.00 | 0.01 |
| ZrO2 | 0.54 | 0.54 | 0.83 |
| Y2O3 | | | 0.95 |
| Sum | 100.00 | 100.00 | 100.00 |
| Properties | | | |
| Density | 2.457 | 2.457 | 2.523 |
| CTE (0-300c) ppm (fiber) | 58.8 | 53.3 | 53.1 |
| Stain Point (fiber Elongation) | 584 | 592 | 599 |
| Annealing Point | 630 | 637 | 644 |
| (fiber Elongation) | | | |
| Softening Point | 836.3 | 840.7 | 842.4 |
| (fiber Elongation) | | | |
| Strain PT (BBV) (10\hat{ }14.68 P) | 582.3 | 590.6 | |
| Annealing PT (BBV) | 627.5 | 635.7 | |
| (10\hat{ }13.18 P) | | | |
| SoftPT(PPV) (10\hat{ }7.6 P) | 836.8 | 845.8 | 838.5 |
| Young′s modulus (GPa) | 84.6 | 85.7 | 88.5 |
| Shear modulus (GPa) | 34.3 | 34.7 | 35.7 |
| Poission′s ratio | 0.233 | 0.235 | 0.240 |
| K1C (CN) | 0.703 | 0.783 | 0.775 |
| STDEV(CN) | 0.049 | 0.020 | — |
| RI @ 589.3 | 1.5275 | 1.5276 | 1.5376 |
| SOC (546.1 nm) single PT | 2.906 | 2.891 | 2.848 |
| VFT parameters from HTV | | | |
| A | −2.618 | −2.483 | −1.964 |
| B | 5878.1 | 5602.5 | 4391.8 |
| To | 256.8 | 281.3 | 392.9 |
| Liquidus (gradient boat) | | | |
| duration (hours) | 24 | 24 | 24 |
| Air ( [symbol] C) | 1195 | 1280 | 1255 |
| internal ( [symbol] C) | 1175 | 1265 | 1230 |
| Pt ( [symbol] C) | 1155 | 1255 | 1220 |
| primary phase | Corundum | Corundum | Corundum |
| 2ndry phase | Spodumene | Spinel | Spinel |
| tertiary phase | Zircon | Spodumene | Zircon |
| liquidus viscosity (Air) Poise | 4439 | 1339 | 1350 |
| liquidus viscosity | 6078 | 1631 | 1916 |
| (Internal) Poise | | | |
| liquidus viscosity (Platinum) Poise | 8439 | 1866 | 2218 |

Substrates with a thickness of 0.6 mm were formed from the compositions of Tables 1-8, and subsequently ion exchanged to form example ion exchanges substrates. The ion exchange included submerging the substrates into a molten salt bath. The salt bath included 93 wt % K and 7 wt % NaNO₃, and was at a temperature of 450° C. In Table II, the length of the ion exchange and the weight gain produced by the ion exchange treatment and the maximum central tension (CT) of the ion exchanged substrates are reported. The maximum central tension (CT) was measured according to the methods described herein.

TABLE 9

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 1 | 2 | 3 | 4 | 5 | 6 |
| Time | 8.0 | 8.0 | 8.0 | 8.0 | 8.0 | 8.0 |
| CS | 902 | 903 | 912 | 908 | 935 | 949 |
| DOL | 4.7 | 6.6 | 9.2 | 4.7 | 4.8 | 4.7 |
| CT | 187 | 173 | 140 | 199 | 192 | 181 |
| Time | 12.0 | 12.0 | 12.0 | 12.0 | 12.0 | 12.0 |
| CS | 857 | 829 | 845 | 850 | 869 | 888 |
| DOL | 6.0 | 8.2 | 11.1 | 6.0 | 6.1 | 6.0 |
| CT | 195 | 135 | 108 | 192 | 177 | 182 |
| Time | 16.0 | 16.0 | 16.0 | 16.0 | 16.0 | 16.0 |
| CS | 813 | 788 | 791 | 808 | 839 | 847 |
| DOL | 6.7 | 9.6 | 13.0 | 6.7 | 6.7 | 6.9 |
| CT | 171 | 107 | 88 | 176 | 140 | 161 |

TABLE 10

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 7 | 8 | 9 | 10 | 11 | 12 |
| Time | 8.0 | 8.0 | 8.0 | 8.0 | 8.0 | 8.0 |
| CS | 926 | 925 | 955 | 893 | 894 | 935 |
| DOL | 4.4 | 4.7 | 4.4 | 4.6 | 4.4 | 4.5 |
| CT | 173 | 186 | 186 | 159 | 160 | 173 |
| Time | 12.0 | 12.0 | 12.0 | 12.0 | 12.0 | 12.0 |
| CS | 856 | 880 | 877 | 862 | 848 | 878 |
| DOL | 6.5 | 6.0 | 6.0 | 6.7 | 5.9 | 5.7 |
| CT | 186 | 194 | 193 | 177 | 183 | 201 |
| Time | 16.0 | 16.0 | 16.0 | 16.0 | 16.0 | 16.0 |
| CS | 819 | 843 | 820 | 836 | 817 | 806 |
| DOL | 7.5 | 6.7 | 6.8 | 7.7 | 6.8 | 6.5 |
| CT | 152 | 182 | 164 | 162 | 161 | 182 |

TABLE 11

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 13 | 14 | 15 | 16 | 17 | 18 |
| Time | 8.0 | 8.0 | 8.0 | 8.0 | 8.0 | 8.0 |
| CS | 896 | 919 | 905 | 895 | 866 | 900 |
| DOL | 5.1 | 4.7 | 4.7 | 5.6 | 4.9 | 4.8 |
| CT | 198 | 199 | 209 | 189 | 190 | 203 |
| Time | 12.0 | 12.0 | 12.0 | 12.0 | 12.0 | 12.0 |
| CS | 849 | 854 | 863 | 823 | 810 | 825 |
| DOL | 5.6 | 5.6 | 5.1 | 5.8 | 5.1 | 5.5 |
| CT | 180 | 184 | 188 | 158 | 159 | 166 |
| Time | 16.0 | 16.0 | 16.0 | 16.0 | 16.0 | 16.0 |
| CS | 813 | 827 | 821 | 773 | 786 | 782 |
| DOL | 6.3 | 6.2 | 6.2 | 6.4 | 6.3 | 5.5 |
| CT | 169 | 177 | 176 | 134 | 154 | 154 |

TABLE 12

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 19 | 20 | 21 | 22 | 23 | 24 |
| Time | 8.0 | 8.0 | 8.0 | 8.0 | 8.0 | 8.0 |
| CS | 916 | 934 | 960 | 943 | 920 | 918 |
| DOL | 7.2 | 5.0 | 3.8 | 4.7 | 4.7 | 4.4 |
| CT | 168 | 198 | 193 | 193 | 185 | 130 |
| Time | 12.0 | 12.0 | 12.0 | 12.0 | 12.0 | 12.0 |
| CS | 877 | 890 | 900 | 911 | 880 | 860 |
| DOL | 9.0 | 6.7 | 4.6 | 6.0 | 5.8 | 5.2 |
| CT | 141 | 195 | 226 | 197 | 187 | 174 |
| Time | 16.0 | 16.0 | 16.0 | 16.0 | 16.0 | 16.0 |
| CS | 816 | 854 | 870 | 877 | 840 | 837 |
| DOL | 10.3 | 7.9 | 5.7 | 7.0 | 6.9 | 6.5 |
| CT | 111 | 164 | 225 | 184 | 167 | 171 |

TABLE 13

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 25 | 26 | 27 | 28 | 29 | 30 |
| Time | 8.0 | 8.0 | 8.0 | 8.0 | 8.0 | 8.0 |
| CS | 889 | 892 | 919 | 919 | 868 | 868 |
| DOL | 4.6 | 4.6 | 4.7 | 4.7 | 4.4 | 4.4 |
| CT | 166 | 182 | 166 | 162 | 174 | 170 |
| Time | 12.0 | 12.0 | 12.0 | 12.0 | 12.0 | 12.0 |
| CS | 847 | 856 | 884 | 890 | 841 | 846 |
| DOL | 6.1 | 6.0 | 6.3 | 6.4 | 5.6 | 5.6 |
| CT | 165 | 176 | 158 | 164 | 174 | 175 |
| Time | 16.0 | 16.0 | 16.0 | 16.0 | 16.0 | 16.0 |
| CS | 815 | 823 | 842 | 874 | 803 | 813 |
| DOL | 6.8 | 6.7 | 6.9 | 6.9 | 6.4 | 6.4 |
| CT | 151 | 147 | 148 | 154 | 161 | 159 |

TABLE 14

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 31 | 32 | 33 | 34 | 35 | 36 |
| Time | 8.0 | 8.0 | 8.0 | 8.0 | 8.0 | 8.0 |
| CS | 1031 | 1045 | 1053 | 992 | 987 | 1024 |
| DOL | 4.3 | 4.0 | 3.7 | 7.1 | 6.9 | 5.4 |
| CT | 193 | 176 | 171 | 159 | 164 | 177 |
| Time | 12.0 | 12.0 | 12.0 | 12.0 | 12.0 | 12.0 |
| CS | 938 | 939 | 951 | 922 | 923 | 972 |
| DOL | 5.2 | 5.1 | 4.8 | 8.6 | 8.5 | 6.5 |
| CT | 188 | 186 | 187 | 122 | 136 | 162 |
| Time | 16.0 | 16.0 | 16.0 | 16.0 | 16.0 | 16.0 |
| CS | 900 | 904 | 910 | 886 | 881 | 911 |
| DOL | 5.6 | 5.4 | 5.3 | 10.3 | 10.1 | 8.2 |
| CT | 173 | 174 | 165 | 109 | 111 | 131 |

TABLE 15

| | IOX Condition | | | | | |
|---|---|---|---|---|---|---|
| | 93K/ | 93K/ | 93K/ | 93K/ | 93K/ | 93K/ |
| | 7Na | 7Na | 7Na | 7Na | 7Na | 7Na |
| | 450 C. | 450 C. | 450 C. | 450 C. | 450 C. | 450 C. |
| | Sample | | | | | |
| | 37 | 38 | 39 | 40 | 41 | 42 |
| Time | 8.0 | 8.0 | 8.0 | 8.0 | 8.0 | 8.0 |
| CS | 1030 | 1070 | 1039 | 1023 | 938 | 951 |
| DOL | 5.6 | 5.3 | 5.2 | 5.4 | 7.1 | 7.2 |
| CT | 193 | 179.7 | 195 | 187 | 164 | 163 |
| Time | 12.0 | 12.0 | 12.0 | 12.0 | 12.0 | 12.0 |
| CS | 962 | 1000 | 961 | 962 | 879 | 875 |
| DOL | 6.9 | 6.7 | 6.5 | 6.8 | 9.1 | 9.3 |
| CT | 178 | 166.9 | 178 | 177 | 133 | 120 |
| Time | 16.0 | 16.0 | 16.0 | 16.0 | 16.0 | 16.0 |
| CS | 896 | 970 | 922 | 922 | 833 | 847 |
| DOL | 8.0 | 7.6 | 7.9 | 7.8 | 10.2 | 10.3 |
| CT | 146 | 152.3 | 149 | 157 | 104 | 106 |

TABLE 16

| IOX Condition | 93K/7Na 450C | 93K/7Na 450C | 93K/7Na 450C |
|---|---|---|---|
| Sample | 43 | 44 | 45 |
| Time | 2.0 | 2.0 | 4.0 |
| CS | 1165 | 1220 | — |
| DOL | 4.7 | 3.3 | — |
| CT | 108 | 109 | 129 |
| Time | 3.0 | 3.0 | 5.0 |
| CS | — | 1111 | 1068 |
| DOL | — | 4.5 | 4.6 |
| CT | 118 | 127 | 143 |
| Time | 4.0 | 4.0 | 6.0 |
| CS | 1111 | 1109 | 1055 |
| DOL | 6.1 | 4.5 | 4.6 |
| CT | 125 | 138 | 148 |
| Time | 5.0 | 5.0 | 7.0 |
| CS | 1093 | 1077 | 1028 |
| DOL | 7.2 | 5.4 | 4.7 |
| CT | 125 | 146 | 150 |
| Time | 6.0 | 6.0 | 8.0 |
| CS | 1069 | 1051 | 1012 |
| DOL | 7.8 | 6.2 | 5.0 |
| CT | 120 | 146 | 151 |

What is claimed is:

1. A glass, comprising:
greater than or equal to 50.4 mol % to less than or equal to 60.5 mol % SiO₂;
greater than or equal to 16.4 mol % to less than or equal to 19.5 mol % Al₂O₃;
greater than or equal to 2.4 mol % to less than or equal to 9.5 mol % B₂O₃;
greater than or equal to 0 mol % to less than or equal to 5.5 mol % MgO;
greater than or equal to 0.4 mol % to less than or equal to 7.5 mol % CaO;
greater than or equal to 0 mol % to less than or equal to 3.5 mol % ZnO;
greater than or equal to 7.4 mol % to less than or equal to 11.5 mol % Li₂O;
greater than 0.4 mol % to less than or equal to 5.5 mol % Na₂O;
greater than or equal to 0 mol % to less than or equal to 1.0 mol % K₂O;
greater than 0.1 mol % to less than or equal to 1.5 mol % ZrO₂; and
greater than or equal to 0 mol % to less than or equal to 2.5 mol % Y₂O₃.

2. The glass of claim 1, comprising:
greater than 0.2 mol % to less than or equal to 1.0 mol % ZrO₂.

3. The glass of claim 1, comprising:
greater than 0.3 mol % to less than or equal to 0.8 mol % ZrO₂.

4. The glass of claim 1, comprising:
greater than or equal to 51.0 mol % to less than or equal to 60.0 mol % SiO₂.

5. The glass of claim 1, comprising:
greater than or equal to 17.5 mol % to less than or equal to 19.0 mol % Al₂O₃.

6. The glass of claim 1, comprising:
greater than or equal to 3.5 mol % to less than or equal to 9.0 mol % B₂O₃.

7. The glass of claim 1, comprising:
greater than or equal to 0.08 mol % to less than or equal to 4.8 mol % MgO.

8. The glass of claim 1, comprising:
greater than or equal to 1.0 mol % to less than or equal to 6.5 mol % CaO.

9. The glass of claim 1, comprising:
greater than or equal to 0 mol % to less than or equal to 2.1 mol % ZnO.

10. The glass of claim 1, comprising:
greater than or equal to 8.9 mol % to less than or equal to 11.0 mol % Li₂O.

11. The glass of claim 1, comprising:
greater than 1.8 mol % to less than or equal to 4.3 mol % Na₂O.

12. The glass of claim 1, comprising:
greater than or equal to 0.1 mol % to less than or equal to 0.5 mol % K₂O.

13. The glass of claim 1, comprising:
greater than or equal to 0 mol % to less than or equal to 1.1 mol % Y₂O₃.

14. The glass of claim 1, comprising:
greater than or equal to 51.9 mol % to less than or equal to 59.1 mol % SiO₂;
greater than or equal to 17.5 mol % to less than or equal to 18.9 mol % Al₂O₃;
greater than or equal to 3.8 mol % to less than or equal to 8.1 mol % B₂O₃;
greater than or equal to 0.05 mol % to less than or equal to 4.8 mol % MgO;
greater than or equal to 1.0 mol % to less than or equal to 6.1 mol % CaO;
greater than or equal to 0 mol % to less than or equal to 2.1 mol % ZnO;
greater than or equal to 8.9 mol % to less than or equal to 11.0 mol % Li₂O;
greater than 1.8 mol % to less than or equal to 4.3 mol % Na₂O;
greater than or equal to 0.15 mol % to less than or equal to 0.25 mol % K₂O;
greater than 0.2 mol % to less than or equal to 1.1 mol % ZrO₂; and
greater than or equal to 0 mol % to less than or equal to 1.1 mol % Y₂O₃.

15. The glass of claim 1, comprising:
greater than or equal to 57.0 mol % to less than or equal to 59.0 mol % SiO₂;
greater than or equal to 18.0 mol % to less than or equal to 18.9 mol % Al₂O₃;
greater than or equal to 3.8 mol % to less than or equal to 5.0 mol % B₂O₃;
greater than or equal to 1.5 mol % to less than or equal to 2.5 mol % MgO;
greater than or equal to 3.0 mol % to less than or equal to 4.0 mol % CaO;
greater than or equal to 0 mol % to less than or equal to 0.5 mol % ZnO;
greater than or equal to 9.0 mol % to less than or equal to 10.0 mol % Li₂O;
greater than 3.0 mol % to less than or equal to 4.0 mol % Na₂O;
greater than or equal to 0.15 mol % to less than or equal to 0.25 mol % K₂O;
greater than 0.4 mol % to less than or equal to 0.8 mol % ZrO₂; and
greater than or equal to 0 mol % to less than or equal to 0.5 mol % Y₂O₃.

16. The glass of claim 1, comprising:
a fracture toughness K₁C greater than or equal to 0.7.

17. The glass of claim 1, comprising:
a fracture toughness K₁C greater than or equal to 0.75.

18. The glass of claim 1, comprising:
a fracture toughness K₁C greater than or equal to 0.7 and less than or equal to 0.9.

19. The glass of claim 1, comprising:
a 10^{7.6} P softening point less than or equal to 850° C.

20. The glass of claim 1, comprising:
a 10^{7.6} P softening point greater than or equal to 750° C. less than or equal to 850° C.

21. The glass of claim 1, comprising:
a 10^{7.6} P softening point greater than or equal to 750° C. less than or equal to 835° C.

22. An article, comprising:
a glass-based substrate, the glass-based substrate further comprising:
a compressive stress layer extending from a surface of the glass-based article to a depth of compression;
a central tension region; and
a composition at a center of the glass-based substrate comprising:
greater than or equal to 50.4 mol % to less than or equal to 60.5 mol % SiO₂;
greater than or equal to 16.4 mol % to less than or equal to 19.5 mol % Al₂O₃;
greater than or equal to 2.4 mol % to less than or equal to 9.5 mol % B₂O₃;
greater than or equal to 0 mol % to less than or equal to 5.5 mol % MgO;
greater than or equal to 0.4 mol % to less than or equal to 7.5 mol % CaO;
greater than or equal to 0 mol % to less than or equal to 3.5 mol % ZnO;
greater than or equal to 7.4 mol % to less than or equal to 11.5 mol % Li₂O;
greater than 0.4 mol % to less than or equal to 5.5 mol % Na₂O;
greater than or equal to 0 mol % to less than or equal to 1.0 mol % K₂O;
greater than 0.1 mol % to less than or equal to 1.5 mol % ZrO₂; and
greater than or equal to 0 mol % to less than or equal to 2.5 mol % Y₂O₃.

23. A method, comprising:
ion exchanging a glass-based substrate in a molten salt bath to form a glass-based article,
wherein the glass-based article comprises a compressive stress layer extending from a surface of the glass-based article to a depth of compression, the glass-based article comprises a central tension region, and the glass-based substrate comprises the glass of claim 1.
